(19) United States
(12) Patent Application Publication
(10) Pub. No.: US 2020/0021912 A1
(43) Pub. Date: Jan. 16, 2020

(54) METHOD FOR ADJUSTING AND CONTROLLING EQUALIZER BY USING TRACKBALL AND SOUND OUTPUT APPARATUS EQUIPPED WITH TRACKBALL

(71) Applicant: Tymphany Acoustic Technology (Huizhou) Co., Ltd., Huizhou City (CN)

(72) Inventors: Yeap Yau LIN, Huizhou City (CN); Yick Hong LAM, Huizhou City (CN); Jinling ZHUANG, Huizhou City (CN)

(21) Appl. No.: 16/506,632

(22) Filed: Jul. 9, 2019

(30) Foreign Application Priority Data
Jul. 12, 2018 (CN) 201810763213.8

(51) Int. Cl. H04R 3/04; G06F 3/16; G06F 3/0354

(52) U.S. Cl. CPC H04R 3/04; G06F 3/03549; G06F 3/165

(57) ABSTRACT

A method for adjusting and controlling an equalizer (EQ) by using a trackball, includes receiving a first signal, the first signal being generated based on an angle by which a vector of the trackball is rolled; receiving a second signal, the second signal being generated based on an angular displacement through which the trackball is rolled; and generating control signals based on the first signal and the second signal, the control signals adjusting and controlling a sound effect of the EQ.

### CROSS REFERENCE TO RELATED APPLICATIONS

This application claims priority under 35 U.S.C. § 119 to Chinese Patent Application No. CN 201810763213.8, which was filed on Jul. 12, 2018, and which is herein incorporated by reference.

### BACKGROUND

### Technical Field

This disclosure relates to a method for adjusting and controlling an equalizer (EQ), and in target, to a method for adjusting and controlling an EQ by using a trackball and a sound output apparatus equipped with the trackball.

### Related Art

A main function of an EQ is to adjust a gain value of a signal in each frequency band. The EQ can optimize some sound by modifying levels of overtones composition of frequencies in the sound, thereby enhancing people's feelings. A user can set the EQ based on a personal preference, so that the EQ can satisfy preferences of different persons while listening to music.

Generally, in a common manner, the EQ is adjusted by using a push-up key or a knob on a panel. That is, the user adjusts the gain value of the signal in each frequency band by pushing a key upward and downward or in a rotation manner. For users, especially for a user who cannot see an EQ controller easily, it is necessary to provide a more convenient and intuitive control manner.

### SUMMARY

In view of this, this disclosure provides a method for adjusting and controlling an EQ by using a trackball, including: receiving a first signal, the first signal being generated based on an angle by which a vector of the trackball is rolled; receiving a second signal, the second signal being generated based on an angular displacement through which the trackball is rolled; and generating control signals based on the first signal and the second signal, the control signals adjusting and controlling a sound effect of the EQ.

In some embodiments, the adjusting and controlling a sound effect of the EQ includes increasing or decreasing a frequency and boosting or cutting amplitude.

The control signal generated based on the first signal is used for adjusting and controlling the EQ to increase or decrease the frequency to a target frequency.

The control signal generated based on the second signal is used for adjusting and controlling the EQ to increase or decrease the amplitude at the target frequency.

In some embodiments, the trackball defines an X-axis and a Y-axis by using a center as an origin, the angle is an angle (α) between a plane formed by the vector mapping to the X-axis and the Y-axis and the X-axis, and the angle (α) ranges from 0 degrees to 360 degrees.

The angular displacement is an angular displacement (θ) formed by the center of the trackball and a start point from which the trackball is rolled and an end point to which the trackball is rolled.

When 0<α<180, a boosted amplitude satisfies a formula: dB_Boost=(θ/π)*(k/r), r being a radius of the ball, and k being a sensitivity parameter; and when the amplitude is boosted, a frequency satisfies a formula: Freq=2\hat{ }(K1*α+B1), K1=(log 2(min_freq)−log 2(max_freq))/π, and B1=log 2(max_freq).

When 180<α<360, a cut amplitude satisfies a formula: dB_Cut=(θ/π)*(k/r), r being a radius of ball, and k being a sensitivity parameter; and when the amplitude is cut, a frequency satisfies a formula: Freq=2\hat{ }(K2*α+B2), K2=(log 2(max_freq)−log 2(min_freq))/π, and B2=log 2(min_freq)−k2*π.

In addition, this disclosure further provides a sound output apparatus, including a loudspeaker, a trackball, a detection module, and a control module. The trackball is electrically connected to the detection module. When the trackball is rolled, the detection module generates a first signal based on an angle by which a vector of the trackball is rolled, and the detection module generates a second signal based on an angular displacement through which the trackball is rolled. The control module is electrically connected to the detection module and the loudspeaker. The control module generates control signals based on the first signal and the second signal, and the control signals adjust and control a sound effect of an EQ of the loudspeaker to output sound by using the loudspeaker.

Briefly, a sound effect can be changed by changing amplitude of a sound wave at a target frequency. Therefore, in the method of this disclosure, the EQ is adjusted by using the trackball, and the EQ can be adjusted and controlled more intuitively.

### BRIEF DESCRIPTION OF THE DRAWINGS

FIG. 1 is a schematic three-dimensional diagram of an embodiment of a sound output apparatus according to this disclosure;

FIG. 2 is a schematic block diagram of an embodiment of a sound output apparatus according to this disclosure;

FIG. 3 is a flowchart of a method for adjusting and controlling an EQ by using a trackball according to this disclosure;

FIG. 4A to FIG. 4I are schematic diagrams of usage statuses of a trackball according to this disclosure; and

FIG. 5A and FIG. 5B are respectively schematic diagrams showing that frequency changes are correspondingly adjusted based on changes of an angle α when an amplitude is boosted and an amplitude is cut.

### DETAILED DESCRIPTION

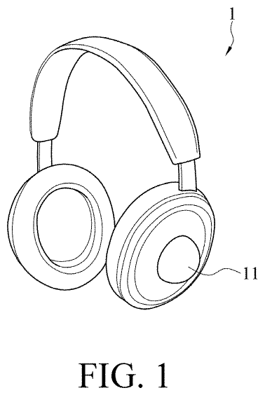

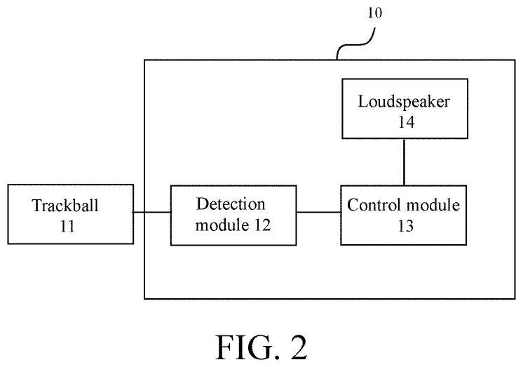

Referring to both FIG. 1 and FIG. 2, this disclosure provides a sound output apparatus equipped with a trackball. The sound output apparatus may be a headset or acoustic equipment, or the like. A headset is shown in FIG. 1, but this disclosure is not limited thereto. The sound output apparatus 1 includes a loudspeaker 14, a trackball 11, a detection module 12, and a control module 13. Further, the loudspeaker 14, the detection module 12, and the control module 13 may be located on a same substrate 10, or may be located on different substrates but are electrically connected to each other. The trackball 11 is electrically connected to the detection module 12 on the substrate 10.

The trackball 11 is electrically connected to the detection module 12. When a user rolls the trackball 11, the detection module 13 generates a first signal based on an angle of a rolling vector of the trackball 11, and the detection module 13 generates a second signal based on an angular displacement. The control module 13 is electrically connected to the detection module 12 and the loudspeaker 14. The control module 13 generates control signals based on the first signal and the second signal, and the control signals adjust and control a sound effect of an EQ of the loudspeaker 14 to output sound by using the loudspeaker 14. The following provides further description by using an example.

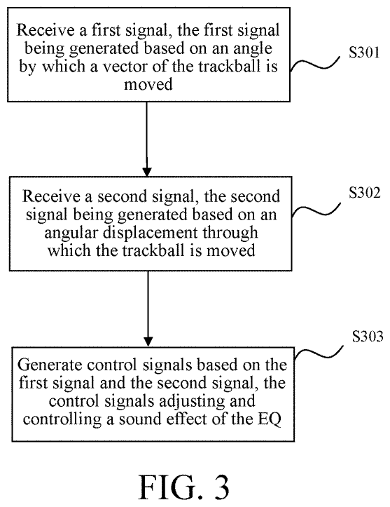

Referring to FIG. 3, this disclosure provides a method for adjusting and controlling an EQ by using a trackball, which includes:

Step S301: Receive a first signal, the first signal being generated based on an angle by which a vector of the trackball is rolled.

Step S302: Receive a second signal, the second signal being generated based on an angular displacement through which the trackball is rolled.

Step S303: Generate control signals based on the first signal and the second signal, and the control signals adjusting and controlling a sound effect of the EQ.

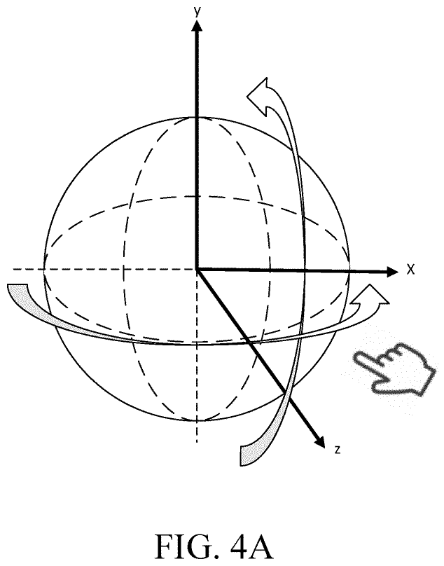

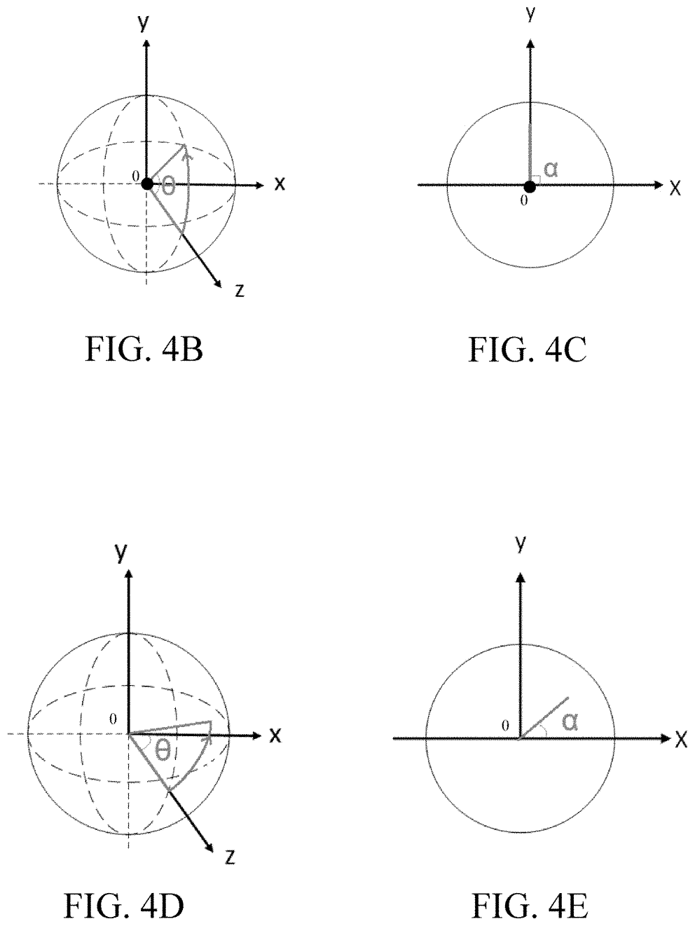

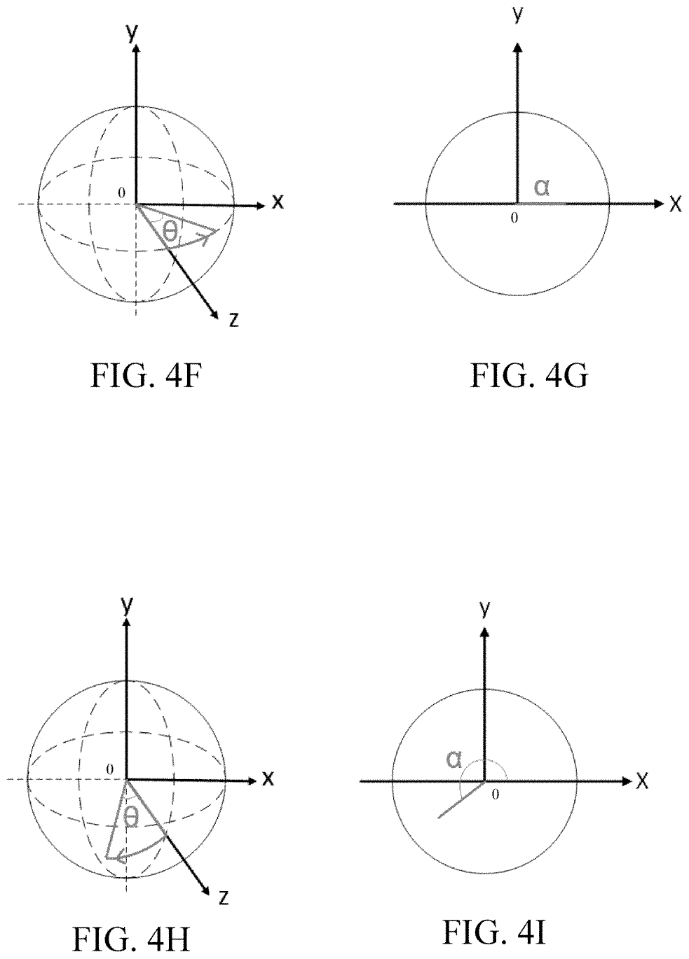

For example, referring to FIG. 4A, FIG. 4A is a schematic three-dimensional diagram of an embodiment of adjusting and controlling the EQ by a user by using the trackball. A center of the trackball is an origin 0, and an X-axis, a Y-axis, and a Z-axis are defined. As shown in FIG. 4B, when the user rolls the trackball upward along the Y-axis, the detection module can detect an angular displacement θ through which the trackball 11 is rolled. Additionally, as shown in FIG. 4C, when the trackball is rolled upward along the Y-axis, the detection module can further detect an angle α by which the vector is rolled relative to the X-axis. The angle α is an angle between a plane formed by the vector mapping to the X-axis and the Y-axis and the X-axis. The angle α ranges from 0 degrees to 360 degrees.

Similarly, when the user rolls the trackball from lower left to upper right (forward/upward), the angular displacement θ and the angle α are shown in FIG. 4D and FIG. 4E. When the user rolls the trackball towards right along the X-axis, the angular displacement θ and the angle α are shown in FIG. 4F and FIG. 4G. When the user rolls the trackball from upper right to lower left (backward/downward), the angular displacement θ and the angle α are shown in FIG. 4H and FIG. 4I.

When 0<α<180, a boosted amplitude satisfies below formula:

dB_Boost=(θ/π)*(k/r), wherein r is the radius of the ball, and k is a sensitivity parameter.

When 180<α<360, a cut amplitude satisfies below formula:

dB_Cut=(θ/π)*(k/r), wherein r is the radius of the ball, and k is a sensitivity parameter. k/r may alternatively be represented as dB_step. As shown in the following Table 1, dB_step is inversely proportional to the radius of the ball (equal to k/r) and is used for adjusting and controlling sensitivity (k) of a rolling amplitude.

TABLE 1

| (k/r) ratio | Angular displacement (θ) | Amplitude |
|---|---|---|
| 6 | 180 forward | 6 dB |
| | | (boosted) |
| 6 | 360 forward | 12 dB |
| | | (boosted) |
| 6 | 180 backward | 6 dB (cut) |
| 6 | 360 backward | 12 dB (cut) |
| 12 | 180 forward | 12 dB |
| | | (boosted) |
| 12 | 360 upward | 24 dB |
| | | (boosted) |
| 12 | 180 downward | 12 dB |
| | | (boosted) |
| 12 | 360 backward | 24 dB (cut) |

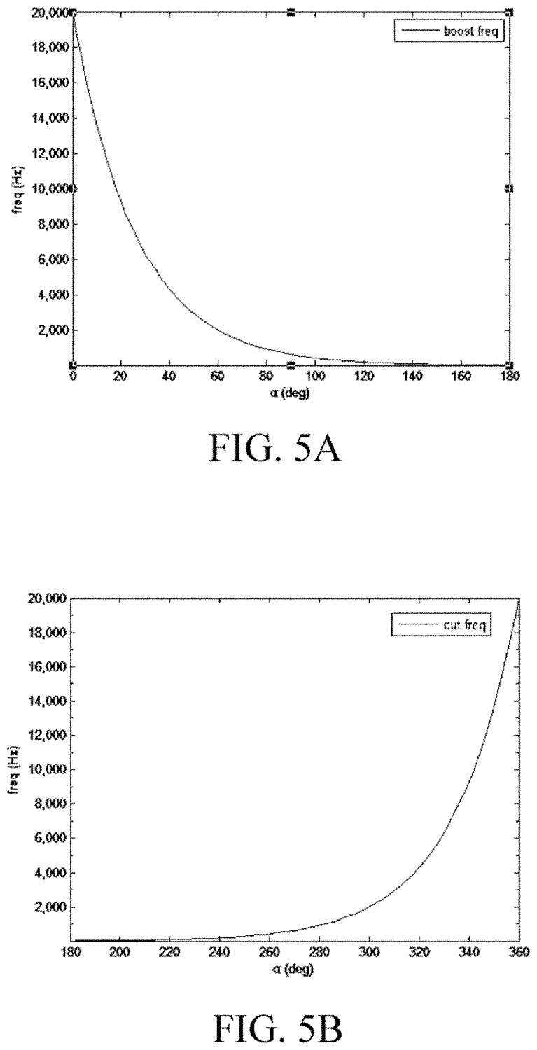

If the amplitude is boosted, the frequency satisfies a formula: Freq=2\hat{ }(K1*α+B1), where K1=(log 2(min_freq)−log 2(max_freq))/π, and B1=log 2(max_freq). As shown in FIG. 5A, a logarithm scale related to the angle α is disclosed.

If the amplitude is cut, the frequency satisfies a formula: Freq=2\hat{ }(K2*α+B2), where K2=(log 2(max_freq)−log 2(min_freq))/π, and B2=log 2(min_freq)−k2*η. As shown in FIG. 5B, a logarithm scale related to the angle α is disclosed.

In this way, according to the method and apparatus in this disclosure, the EQ can be adjusted and controlled by using the trackball. Therefore, the EQ is adjusted and controlled more intuitively.

Although this disclosure is disclosed as above by using the embodiments, the embodiments are not intended to limit this specification, and any person skilled in the art can make some variations and modifications without departing from the spirit and scope of this disclosure. Therefore, the protection scope of this disclosure should be subject to the scope defined by the claims.

What is claimed is:

1. A method for adjusting and controlling an equalizer (EQ) by using a trackball, comprising:
receiving a first signal generated based on an angle by which a vector of the trackball is rolled;
receiving a second signal generated based on an angular displacement through which the trackball is rolled; and
generating control signals based on the first signal and the second signal,
wherein the control signals adjust and control a sound effect of the EQ.

2. The method for adjusting and controlling an EQ by using a trackball according to claim 1, wherein the adjusting and controlling the sound effect of the EQ comprises increasing or decreasing a frequency and boosting or cutting amplitude.

3. The method for adjusting and controlling an EQ by using a trackball according to claim 2, wherein the control signal generated based on the first signal is used for adjusting and controlling the EQ to increase or decrease the frequency to a target frequency.

4. The method for adjusting and controlling an EQ by using a trackball according to claim 2, wherein the control signal generated based on the second signal is used for adjusting and controlling the EQ to increase or decrease the cutting amplitude at the target frequency.

5. The method for adjusting and controlling an EQ by using a trackball according to claim 1, wherein the trackball defines an X-axis and a Y-axis by using a center as an origin, the angle is an angle (α) between a plane formed by the vector mapping to the X-axis and the Y-axis and the X-axis, and the angle (α) ranges from 0 degrees to 360 degrees.

6. The method for adjusting and controlling an EQ by using a trackball according to claim 5, wherein the angular displacement is an angular displacement (θ) formed by the center of the trackball and a start point from which the trackball is rolled and an end point to which the trackball is rolled.

7. The method for adjusting and controlling an EQ by using a trackball according to claim 6, wherein when 0<α<180, a boosted amplitude satisfies a formula:
dB_Boost=(θ/π)*(k/r), r being a radius of the ball, and k being a sensitivity parameter; and
a frequency satisfies a formula: Freq=2\hat{ }(K1*α+B1), K1=(log 2(min_freq)−log 2(max_freq))/π, and B1=log 2(max_freq).

8. The method for adjusting and controlling an EQ by using a trackball according to claim 6, wherein when 180<α<360, a cut amplitude satisfies a formula:
dB_Cut=(θ/π)*(k/r), r being a radius of the ball, and k being a sensitivity parameter; and
a frequency satisfies a formula: Freq=2\hat{ }(K2*α+B2), K2=(log 2(max_freq)−log 2(min_freq))/π, and B2=log 2(min_freq)−k2*η.

9. A sound output apparatus, comprising:
a loudspeaker;
a trackball;
a detection module electrically connected to the trackball, wherein when the trackball is rolled, the detection module is configured to generate a first signal based on an angle by which a vector of the trackball is rolled, and/or the detection module is configured to generate a second signal based on an angular displacement through which the trackball is rolled; and
a control module electrically connected to the detection module and the loudspeaker, wherein the control module is configured to generate control signals based on the first signal and the second signal, and the control signals adjust and control a sound effect of an equalizer (EQ) of the loudspeaker, to output sound by using the loudspeaker.

10. The sound output apparatus according to claim 9, wherein the adjusting and controlling a sound effect of an EQ comprises increasing or decreasing a frequency to a target frequency, and boosting or cutting amplitude at the target frequency.
